(19) United States
(12) Patent Application Publication
(10) Pub. No.: US 2003/0138658 A1
(43) Pub. Date: Jul. 24, 2003

(54) Multilayer thermal barrier coating

(76) Inventors: Thomas Alan Taylor, Indianapolis, IN (US); Danny Lee Appleby, Indianapolis, IN (US); Ann Bolcavage, Indianapolis, IN (US)

Correspondence Address: PRAXAIR, INC., LAW DEPARTMENT - M1 557, 39 OLD RIDGEBURY ROAD, DANBURY, CT, 06810-5113, US

(21) Appl. No.: 10/051,228

(22) Filed: Jan. 22, 2002

(51) Int. Cl. C03C 27/02; B32B 15/04

(52) U.S. Cl. 428/632; 428/701; 428/699; 416/241 B; 428/304.4

(57) ABSTRACT

The invention provides a multilayer ceramic coating for applying thermal barrier protection to a substrate. It has an inner ceramic layer coating the substrate. The inner ceramic layer has a plurality of macrocracks distributed throughout the inner ceramic layer. An outer ceramic layer coats the inner ceramic layer. The outer ceramic layer is substantially free of vertical macrocracks.

### FIELD OF THE INVENTION

This invention relates to ceramic coatings that are useful as both thermal barriers and as abradables. The invention also relates to articles having ceramic thermal barrier and abradable coatings and to methods of producing these coatings.

### BACKGROUND OF THE INVENTION

Thermal barrier coatings (TBCs) are used to reduce the flow of thermal energy through the coating between its interface with the external environment and the substrate upon which the coating is applied. The primary component of most thermal barrier coatings is a ceramic because of the low thermal conductivity of many ceramic materials. Thermal barrier coating systems usually include metallic undercoats to enhance the bond strength of the coating to the substrate, provide corrosion protection for the substrate, and improve the thermal shock and thermal fatigue resistance of the coating. Thermal barrier coatings have many uses, including a number of applications in gas turbine engines. Modern gas turbine engines for aircraft, ship, or ground-based propulsion or for electrical power generation are continually pushed to higher gas operating temperatures to increase overall efficiency. Some gas turbines operate at such high gas temperatures that directly heated metallic components such as combustors, blades, and vanes would have a very short life, if not given a protective ceramic thermal barrier coating.

There are many variations of thermal barrier coatings, based on the materials selected for the coating and the coating processes. When used on gas turbine components, a metallic bondcoat is usually applied to the metallic substrate (component), and over the bondcoat a ceramic layer, usually based on zirconium oxide (zirconia), is applied. Zirconia has very low thermal conductivity compared to metallic alloys and many other ceramics. The zirconia layer of the coating is usually rather thin, say from 10 mils (0.25 mm) on blades and vanes up to 80 mils (2 mm) on combustors. Yet the coating can reduce the substrate's temperature by 100 to more than 200 degrees Fahrenheit (56 to more than 111 degrees Celsius), depending on the hot and cold side boundary conditions.

The bondcoat usually serves at least three purposes. It improves the bond strength, protects the substrate from oxidation or other forms of corrosion, and provides improved resistance to thermal shock and thermal fatigue. There are many bondcoat compositions including Ni—Al alloys (including the Ni—Al intermetallics), Ni—Cr alloys, MCrAl alloys (where M is Fe, Ni, Co, or a combination thereof and the alloy may also contain Y, Hf, Si, Pt, and other active elements), diffusion aluminides, platinum aluminides, or other modified aluminides. There are a number of methods of applying these bondcoats depending on their composition including: thermal spray (air plasma spray, low pressure or vacuum plasma spray, high velocity oxyfuel, etc.,), physical vapor deposition (PVD), electroplating, and diffusion. Bondcoats usually range in thickness from 3 to 10 mils (0.08 to 0.25 mm). When deposited by thermal spray techniques, it is usually necessary to heat treat the bondcoat at a high temperature to eliminate or close the inherent porosity in the coating by sintering. This heat treatment may be done either before or after the ceramic coating is applied over the bondcoat.

The ceramic coating is usually based on zirconia, which may be fully or partially stabilized with yttria, the rare earth oxides, magnesia, hafnia, or other oxides. The ceramic coating may be deposited by thermal spray (principally plasma spray), electron beam physical vapor deposition (EBPVD), other PVD, sol gel, or other techniques. The microstructure of the ceramic strongly affects its thermal and thermomechanical properties. The microstructure of an EBPVD thermal barrier coating typically has a columnar structure for reducing the elastic modulus in the plane of the coating and increase the thermal shock and thermal fatigue resistance of the coating. The most common microstructure for a thermal spray ceramic thermal barrier coating is simply one with a high level of porosity. A high level of porosity can be achieved by proper selection of the deposition parameters or by incorporating a fugitive material such as a polyester in the coating during deposition. The fugitive material is subsequently decomposed leaving pores and creating additional porosity in the coating. A variety of thermal conductivity measurements have been carried out, such as laser pulse thermal diffusivity tests combined with specific heat and density measurements to characterize the thermal properties of coating systems. In addition to this, isothermal and gradient thermal shock test rigs have been developed to simulate engine thermal shock. It is generally found that a uniform ceramic coating, such as one having constant density and structure throughout its thickness, has a thickness limitation for good thermal shock performance. For example, simple yttria-stabilized zirconia applied by plasma spray methods at a density of about 85 percent of theoretical (15 percent true porosity) can pass most thermal cycling tests up to about 20 mils (0.5 mm) ceramic thickness. At greater thickness however, spallation can occur, depending on the severity of the thermal shock test.

In a gas turbine engine there are blades and air (gas) seals in the compressor section of the gas turbine, whose purpose is to increase the pressure and temperature of the air by multiple blade stages and deliver warm-high-pressure air to the combustor. In the combustor section, fuel is injected and the fuel-air mixture burned to produce very hot, even higher pressure gaseous combustion products. The hot-high-pressure combustion products exit the combustor and work to rotate the blades in the turbine section, where the thermal energy is thus converted to mechanical energy. In addition to operating a gas turbine engine at high gas temperatures, there are other factors that contribute to engine efficiency. One of these is the amount of air in the compressor section or combustion gas in the turbine section that flows over the tips of the blades or vanes rather than flowing over the blade airfoil surfaces. Minimizing this amount increases the turbine efficiency. This is accomplished by placing radially adjacent to the tips of the rotating blades, but slightly spaced away from the tips, an outer gas seal ring or segments of a ring. These rings or segments are stationary and are set to have as small a gap between the surface of the gas seal and the rotating blade tips as possible. The smaller the gap, the less leakage of the high-pressure gas from one turbine or compressor stage to the next. A similar situation exists between rotating knife edges and inner gas seals on stationary vanes.

The gap between the gas seal surface and the blade tips (or the knife edges) needs to be minimized to prevent gas pressure leakage between the stages. If the gap is set too close, then it is possible that the blade tips may rub the gas seal surface. This may occur due to increased blade length due to thermal expansion or to centrifugal forces resulting from the high rotation speed. If the gap is set too loose, such that a tip rub would never occur, engine efficiency is sacrificed. In the case of a rub, either the blade tip or the gas seal surface or both will experience wear. Wear results in the loss of material from the blade or air seal. Material loss primarily from the blade tip has the effect of permanently increasing the gap. Wear loss mainly from the gas seal is more desirable. Gas seals are designed slightly wider than the blade width so that a wear track in the air seal is a groove as wide as the blade tip chord, but with some material at the leading and trailing edges of the air seal not rubbed. This groove provides a labyrinth-like flow path for the high pressure gas that does not result in as much gas pressure drop as would occur if the same amount of wear were all on the blade tip. So it is preferred that the wear be primarily into gas seal segment surfaces and minimized on blade tips. It is possible to force the majority of wear to the gas seal segment by coating it with an abradable coating, and coating the blade tip with a wear-resistant coating, or even an abrasive tip coating. It is advantageous, particularly in the turbine section where it may even be necessary, for the abradable to also be a thermal barrier coating to protect the metallic seal substrate. This increases the efficiency of the engine by either allowing higher gas operating temperatures or by reducing the amount of by-pass cooling air necessary to keep the seal segments within their allowable operating temperature range.

Many attributes may have to be met simultaneously by a coating on a seal segment or ring including, as noted above, that it may have to be both abradable and a thermal barrier. The abradability of a material is a function of a number of factors including the material's mechanical strength, density, friability, temperature of operation, nature of interacting at its rub surface, etc. Laboratory scale rub tests have been developed to help guide the choice of material for its abradability. The results of all testing to date have shown that the amount and distribution of wear depend not only on the material providing the abradable gas seal, but also on the material on the rubbing tip. An early attempt to provide increased abradability combined with a wear resistant tip is illustrated by Vine et al., in U.S. Pat. No. 4,936,745. Vine et al. disclose increasing the abradability of zirconia by increasing its porosity. In this case, the coating system consists of a metallic MCrAlY bondcoat 5 to 10 mils (0.13 to 0.25 mm) thick and an yttria partially stabilized zirconia top coating with a porosity of 20 to 35 volume percent, 25 to 50 mils (0.6 to 1.3 mm) thick mated against an abrasive blade tip or knife edge. The effective thickness of this coating is limited however, since this approach provides too little thickness for many applications.

As noted above, the effective thickness of most thermal barriers is limited because their thermal shock resistance decreases as their thickness increases. Yet, thicker ceramic coatings are desired for gas seals to meet increasing thermal insulation requirements, allow for greater incursion of the blade tips or other wear and to have enough material initially present to allow the gas seal ring to be case-ground to a final dimension. The latter is particularly important when the gas seal ring is ground to a diameter, the origin of which is offset from the mechanical center of the ring.

One approach to a somewhat thicker abradable thermal barrier coating is a multiple-layer metal and ceramic system described by Matarese et al., in U.S. Pat. No. 4,588,607. This coating consists of first a metallic bondcoat, then a graded metallic/ceramic layer with a gradually increasing ceramic content and finally an optional ceramic outer layer. Production of the coating involves complex stress analysis and control of many variables, primarily the temperature of the substrate and coating, during the thermal spray deposition of the coating system. It is thus an inherently difficult process to control and expensive. Similarly, Bosshart et al., in U.S. Pat. Nos. 4,481,237 and 4,503,130 describe multilayer coatings that contain a metallic bondcoat, intermediate layers with increasing ceramic content, and a ceramic outer layer. The multilayer coatings attempt to control ratio of stress to strength and therefore strain in the coating by control of the temperature as each layer is deposited. Again, this is a very difficult process to control and hence expensive.

Taylor, in U.S. Pat. No. 5,073,433 discloses a relatively dense ceramic thermal spray coating, generally using yttria-stabilized zirconia. The microstructure of this coating, utilizes vertical crack segmentation to enhance thermal shock and thermal fatigue resistance. Furthermore, this coating has little long-range internal stress and by itself can be coated to very high thickness and still be resistant to thermal shock. The major impediment to utilizing this coating as a gas seal is its high density and, hence, its limited abradability.

Another approach to somewhat thicker abradable thermal barrier coatings is a complex multilayer coating described by Nissley et al. in U.S. Pat. No. 5,705,231. An initial MCrAlY bondcoat is followed with a zirconia “foundation” layer consisting of a specific mixture of different zirconia compositions. Multiple layers are then deposited on the foundation layer. Each layer has a different proportion of the zirconia compositions. Finally a top layer of a more abradable mixture of the zirconia compositions is deposited. The deposition parameters are chosen to generate vertical segmentation cracks in all the zirconia layers with 4 to 8 segmentation cracks per linear inch (1.6 to 3.1 cracks per linear centimeter). This coating requires multiple blends or mixtures of oxides and is limited in thickness to about 50 mils (1.3 mm).

### SUMMARY OF THE INVENTION

The invention provides a multilayer ceramic coating for applying thermal barrier protection to a substrate. It has an inner ceramic layer coating the substrate. The inner ceramic layer has a plurality of macrocracks distributed throughout the inner ceramic layer. An outer ceramic layer coats the inner ceramic layer. The outer ceramic layer is substantially free of vertical macrocracks.

### BRIEF DESCRIPTION OF THE DRAWINGS

FIG. 1 is a micrograph of a polished cross section at 100× magnification of a multilayer coating of Example 1. Shown at the bottom is the substrate alloy with a 5 mil (0.13 mm) thick HVOF CoNiCrAlY bondcoat, then 10 mils (0.25 mm) of a plasma sprayed vertically cracked segmented yttria partially stabilized zirconia, then at the top 40 mils (1 mm) of plasma sprayed low density (65% of theoretical) yttria partially stabilized zirconia.

FIG. 2 is a micrograph of a polished cross section at 5× magnification of a multilayer coating of Example 2. Shown at the bottom is the substrate alloy with a 5 mil (0.13 mm) thick HVOF CoNiCrAlY bondcoat, then 115 mils (2.9 mm) of plasma sprayed vertically cracked segmented yttria partially stabilized zirconia, then 40 mils (1 mm) of plasma sprayed low density (65% of theoretical) yttria partially stabilized zirconia.

FIG. 3 is a micrograph of a polished cross section at 100× magnification of a coating of Example 3. It is a bricked coating of the DOE of Example 3 that successfully passed the thermal shock test with no spallation and only 8% edge cracking after 2000 cycles to 2550° F. (1399° C.). Shown at the bottom is the substrate alloy with a 5 mil (0.13 mm) thick plasma sprayed CoNiCrAlY bondcoat, then 36 mils (0.9 mm) of plasma sprayed yttria partially stabilized zirconia with 63 CPI (cracks per linear inch) or 25 cracks per linear cm vertical cracking and 34% bricking (measured on the full width of the sample).

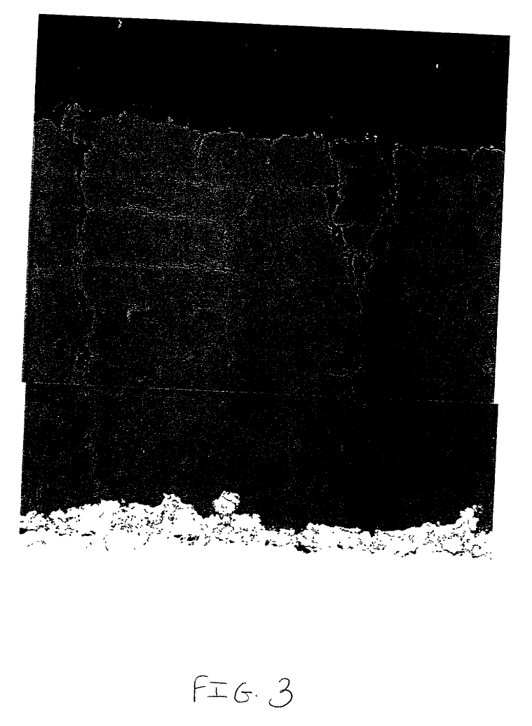

### DETAILED DESCRIPTION

This invention provides coatings that are excellent thermal barriers, excellent abradables, or both. In addition, this invention provides coatings that facilitate depositing much thicker thermal barrier coatings than previously was possible; and these thicker coatings retain excellent thermal shock and thermal fatigue resistance not possible with conventional thermal barrier coatings. The coatings comprise multiple layers of ceramic materials with different microstructures that provide the coating system with much greater thermal shock resistance. The ceramic materials used in the invention are usually oxides, most often based on zirconia, and are thus capable of operation at high temperatures, such as those obtained in the high temperature turbine section of gas turbine engines. The coating systems may also find utility in the compressor section of gas turbine engines and in other applications.

As noted in the Background section above, low density oxide coatings, particularly low density zirconia coatings, are good thermal barriers and may have good abradability, but even with a metallic bondcoat they usually do not have adequate thermal shock and thermal fatigue resistance, if they are more than about 20 mils (0.5 mm) thick. Thicker coatings are required for many applications, for example in gas turbine engines to provide adequate thermal protection and to provide adequate thickness to allow for initial grinding to design tolerances and to allow for incursion of the blade tips and other wear. This is particularly true for coatings used as abradable thermal barriers on seals in gas turbine engines. Advantageously, this invention includes a coating system that has an outer layer of low density oxide, particularly low density zirconia, that is a good abradable thermal barrier and that may be substantially thicker than 20 mils (0.5 mm) and still have adequate thermal shock and thermal fatigue resistance.

It has been found that coatings with multiple layers, wherein an inner layer between the substrate or bondcoat and the low density oxide outer layer has a unique macrocracked microstructure, can be produced with an unusually thick low density top or outer layer coating and still retain adequate thermal shock and thermal fatigue resistance. This is most unexpected, since it would normally be thought that cracks would lead to spallation of the top layers of a coating under conditions of thermal shock or thermal fatigue such as those experienced in gas turbine engines.

Macrocracks, as defined herein, are those cracks visible in a polished cross section of the coating at 100× magnification. Advantageously, the inner ceramic layer's macrocracks are vertical with respect to the substrate. Vertical macrocracks are those that are predominantly perpendicular or normal to the plane of the interface of the coating with the substrate with a length that is at least the lesser of 4 mils (0.1 mm) or one half the coating layer's thickness. If they are at least half the coating layer's thickness, they may also be called segmentation or vertical segmentation cracks. And for purposes of this specification, horizontal macrocracks are those that are predominantly parallel to the plane of the surface of the substrate and connect one segmentation crack with an adjacent segmentation crack. Most advantageously, the inner ceramic layer contains a combination of vertical and horizontal macrocracks for increasing the life of the multilayer coating.

The multilayer coating's inner ceramic layer advantageously has vertical macrocracks that extend at least the lesser of about 0.1 mm in length or one half the thickness of the inner ceramic layer. Most advantageously these vertical macrocracks are segmentation cracks that extend at least one half the thickness of the inner ceramic layer. In addition, these vertical segmentation macrocracks advantageously have a crack density of about 7.5 to 75 vertical macrocracks per linear centimeter. When the multilayer coating's inner ceramic layer includes horizontal macrocracks, the total horizontal macrocracks advantageously extend from about 15 to 100 percent as cummulatively measured across a plane normal to the interface of the substrate with the multilayer coating. Most advantageously, the total horizontal macrocracks extend from about 20 to 60 percent as cummulatively measured across a plane normal to the interface of the substrate with the multilayer coating.

The multilayer coating, such as a zirconia-based coating, most advantageously contains horizontal macrocracks in addition to the vertical macrocracks to form a brick-like structure with a multitude of horizontal cracks of lengths ranging from 5 to 100 mils (0.13 to 2.5 mm) and extending collectively from 15 to 100 percent as measured across a plane that extends the width of the coating (referred to herein as a bricked microstructure).

It has been found that at least one of the macrocracked microstructures of the multilayer coating can be advantageously deposited in a thick layer that retains high thermal shock and thermal fatigue resistance. If the inner layer is composed of two or more sublayers of differently macrocracked microstructures, then the coating may have even greater thermal shock and thermal fatigue resistance. For example, the inner layer may include a first cracked layer and a second cracked layer. Additional inner ceramic layers of varied macrocrack orientations and densities can provide incremental increases to the multilayer coating's life. For example, alternating between inner ceramic layers containing only vertical macrocracks and layers containing both vertical and horizontal macrocracks may further increase the multilayer coating's life.

Optionally, the inner and outer ceramic layers have a porosity that increases from its inner surface to its outer surface. This increased porosity at the outer surface reduces the coating's thermal conductivity and may increase its abradability.

The coatings usually have multiple layers comprising the following: i) an optional metallic bondcoat; ii) an inner ceramic layer with one or more sublayers, each with a predetermined macrocrack pattern; and, iii) a contiguous ceramic outer layer with essentially no vertical macrocracks. The outer ceramic layer forms a contiguous or continuous coating over the macrocrack-containing inner ceramic layer. Most advantageously, the outer ceramic layer contains no vertical macrocracks.

The various layers of the coatings are usually produced using one or more thermal spray process such as plasma spray, detonation gun, high velocity oxy-fuel (HVOF), or high velocity air-fuel (HVAF). One or more of the layers may also be produced using chemical vapor deposition, physical vapor deposition, electrolytic deposition, sol gel, or other deposition techniques.

Advantageously, a metallic bondcoat, if one is used, is chosen to enhance the bond strength of the coating to the substrate, provide corrosion protection for the substrate, and enhance the thermal and mechanical properties of the coating, particularly its thermal shock and thermal fatigue resistance. When the coating is used in the turbine section of a gas turbine, the substrate is usually a nickel or cobalt base alloy and the bondcoat is usually a nickel aluminum alloy or compound, a modified nickel aluminum alloy or compound such as platinum nickel aluminum alloys or compounds, or an MCrAlY alloy where M is Ni, Co, or Fe or combinations thereof and the alloy may also contain Pt, Hf, Si, and other elements. As noted above, when the bondcoat is deposited by thermal spray, it usually has interconnected porosity that reduces its ability to protect the substrate from oxidation or other corrosion. Thus the bondcoat may be heat treated at a high temperature to effect sintering and sealing or elimination of porosity. The most effectively sealed bondcoats are deposited with as high a density as possible and the least amount of oxidation during deposition. These coatings are usually deposited using relatively fine, dense powders and torch parameters that ensure complete melting of the powder; and, as a result, they tend to have a relatively smooth surface. However, it has been found in some cases, depending on the specific ceramic composition and microstructure, that a rough surface on the bondcoat (i.e., greater than about 150 microinches (3.8 μm) and in some cases preferably greater than about 300 microinches (7.6 μm), Rₐ) enhances the bond to the subsequently deposited ceramic layers. For these cases, it has been found to be advantageous to use two sublayers in the bondcoat structure. The first being a very dense coating that can be effectively sealed by heat treatment and the second being a coating produced with a rough surface. The latter may be achieved by using relatively coarse, porous powder and using deposition parameters that do not fully melt the powder. The bondcoat can be heat treated, in an inert atmosphere or preferably a vacuum, either after all its sublayers are deposited or after the ceramic layers are deposited. The thickness of the bondcoat may vary depending on its composition and the requirements of the total coating system. For the thermal spray coatings, the bondcoat thickness is usually about 3 to 100 mils (0.07 to 2.5 mm) with a preferred range of about 5 to 20 mils (0.13 to 0.5 mm).

The macrocracked ceramic layer or layers are usually a zirconia-based ceramic that is stabilized either fully or partially with yttria, ceria, other rare earth oxides, magnesia, or another oxide to stabilize at least one of the tetragonal or cubic crystallographic phases. However, the ceramic layer or layers may be other ceramics such as alumina, chromia, or magnesia based oxides.

The low density outer ceramic or oxide coatings optionally have a density of about 45 to 90 percent of theoretical. Advantageously, the outer coating's density is about 45 to 90 percent theoretical, more advantageously 50 to 86 percent theoretical, and most advantageously density is about 50 to 70 percent theoretical. The preferred composition of the low density coatings is usually stabilized zirconia that is fully or partially stabilized with yttria, ceria, other rare earths, magnesia, or other oxide. However, the low density outer ceramic may be other oxides such as alumina, chromia, or magnesia. The use of these low-density coatings may be optional or unnecessary in some applications; e.g., those in which the coating is not subject to abrasion or in locations adjacent to high hardness blades.

In the multilayer coatings of zirconia-based materials, the thermal conductivity is already quite low because of the inherent low thermal conductivity of zirconium oxide. However, in addition, it has been discovered that some of the structures developed for this multilayer system have features that further modify the thermal conductivity. These include the very low density and thus high porosity of the upper abradable layer, the vertical cracks developed for the segmented microstructures, and the horizontal cracks developed for the bricked microstructures. The thermal conductivity was measured for several of the individual layers using the laser flash thermal diffusivity method. The specific heat was separately measured and the density of the coating was determined from the immersion method of ASTM B-328. From these values, the thermal conductivity was calculated using standard equations. The thermal conductivity was found to be significantly different for the different layers of the multilayer system. It has now been found that the through-thickness thermal conductivity of the multilayer coatings of this invention can be selected and produced by adjusting the thickness of the individual layers. For example, the inner ceramic layer, such as a stabilized zirconia layer, may contain a first layer having a first thermal conductivity and a first thickness and a second layer having a second thermal conductivity and a second thickness. Then controlling the thickness of the first and second layers combines the two different thermal conductivities and forms a desired total conductivity and a desired total thickness.

Test and Evaluation Methods

Standard metallographic techniques were used to examine and characterize the microstructures of the coatings. Cross sections of the coating samples were first vacuum impregnated with an epoxy to preserve the structure, then embedded in standard metallographic mounts, and finally ground and polished to expose a cross sectional plane through the coating perpendicular to the substrate. Many of the coatings described herein include a variety of cracks; this is particularly true of thermal spray coatings. Some of the cracks in thermal spray coatings are very fine and are only revealed in the polished cross sections at high magnifications.

A quantitative characterization of the macrocrack patterns observed in the polished cross-section of the coatings consisted of counting, at a magnification of 100×, only those vertical segmentation macrocracks that were longer than one-half of the coating layer thickness. Knowing the length of the coated sample, the CPI were calculated and then converted to cracks per centimeter. The horizontal macrocracks had a different counting rule. In many areas of the coating, horizontal cracks connected two adjacent vertical segmentation cracks, and in some cases at several levels between a given pair of vertical macrocracks, similar to a ladder structure. Only the length of the longest horizontal crack in such a pattern was measured. If a horizontal crack only contacted one vertical crack it was not counted. Some of the structures developed had many vertical and horizontal cracks in one coating, such that the microscopic view was similar to a brick wall, so the value representing the horizontal cracks was termed the “percent bricking”. Percent bricking was defined as the sum of all horizontal crack lengths across the whole polished cross-section (their collective length), meeting the above rules, divided by the total length of sample observed. Percent bricking could range from zero, where no two vertical cracks are connected with a horizontal crack, up to 100 percent where horizontal cracks ran the full width of the polished cross-section—but not in a continuous line or plane.

An important characteristic of the coatings relative to their abradability and thermal shock is their density. The densities of the coatings evaluated herein were determined using the immersion method (ASTM B-328-73). A value of 6.05 gm/cm³ was used as the theoretical density of fully dense 7 weight percent yttria-stabilized zirconia (YSZ) bulk material assuming a tetragonal crystal structure. The theoretical density (TD) is the density of the material in a fully compacted, pore-free state. The theoretical density of YSZ varies slightly with the amount of yttria and the crystallographic phases present.

A laboratory test was developed to simulate the interaction of blade tips and seal rings or segments in a compressor or turbine section of a gas turbine engine. It is used to evaluate the abradability of coatings and the wear resistance of blade tips or blade tip coatings in various combinations and under various tip speeds and incursion rates (infeed rates) of the blade tip into the seal segment. The test apparatus or rig had no auxiliary heating, but frictional heating was high in some cases. The seal segment in this test was a flat plate about 1.5 inch wide by 1.5 inch (3.8×3.8 cm) long and 0.375 inch (0.95 cm) thick. The seal coating was deposited on one of the 1.5 by 1.5 inch (3.8×3.8 cm) faces. The blade was about 0.55 inch (1.4 cm) long with a flat tip and a cross section of 0.75 by 0.10 inch (1.9×0.25 cm). The blade was held in a rotating flywheel such that the blade tip described a circle of rotation 8 inches (20 cm) in diameter. The coated seal segment was held in a fixture that was moved toward the rotating blade in the flywheel by a controlled stepping motor drive. This caused the blade to contact and cut into the seal segment. The wear track in the seal was thus a 0.75 inch (1.9 cm) wide scallop having a radius of 4 inches (10 cm). For all of the experiments described herein, the tip speed was 156 ft/sec (47.5 m/s) and the infeed rate was 0.05 mils/sec (0.0013 mm/s). The measure of wear on the seal segment was taken to be the average maximum depth of the wear track and on the tip, the average loss of length (depth of wear) across the tip.

To give the test results better comparability, a constant total wear loss (maximum depth in the seal plus depth of wear on the tip) of 10 mils (0.25 mm) was chosen. Since obtaining that amount exactly in every test would be experimentally difficult due to the uncertainty of the start of the rub, two tests were usually run for each set of conditions, one to a wear loss of about 7 mils (0.18 mm) and one to about 14 mils (0.36 mm), and the results interpolated to 10 mils (0.25 mm). One way to express the test result is to calculate the length loss by the tip sample divided by the maximum depth of the wear scar in the seal coating. This is the tip-to-seal wear ratio, a common term used by those working in this field. Ideally, a tip-to-seal wear ratio for a good tip and seal pair is about 0.1 or even better, 0.05. Another parameter expressing the same result is the fraction of total wear on the tip. If WR is the tip-to-seal wear ratio, and FT is the fraction of the total wear on the tip, then

FT=WR/(1+WR).

The FT corresponding to a WR of 0.05 is 0.0476. That is, 4.76 percent of the total wear would be borne by the tip, which would be an acceptable result by engine designers.

The thermal shock resistance of the coatings was characterized in a cyclic thermal shock test. The coating of interest was deposited on one face of substrates of alloy 718 (50-54Ni-17-21Cr-1Co-2.8-3.3Mo-4.75-5.5Nb-0.65-1.15Ti-0.2-0.8Al-0.08C-0.35Mn-0.35Si-0.006B-bal.Fe) or Mar M 509 (Co-23.5Cr-7W-3.5Ta-1 Ni-0.6C-0.5Zr-0.2Ti) superalloys that were 1 inch (2.5 cm) in diameter and 0.125 inch (0.32 cm) thick. These samples were then ground on the periphery to a diameter of 0.94 inch (2.4 cm) exposing the edges of all the layers of the coating with no coating wrapping around the substrate. The samples were held in a fixture that moved the samples to a heating position with a flame impinging on the coated face where they were held for 20 seconds, then to a position where the coated face was cooled with a blast of nitrogen gas for 20 seconds, and finally to two positions where the samples cooled in ambient air for 20 seconds in each position. This cycle was repeated 2000 times. The front face of the ceramic coating typically reached a temperature of about 2500 to 2600° F. (1371 to 1427° C.), while the opposite, uncoated side of the sample reached a temperature of about 1200 to 1700° F. (649 to 927° C.) at the end of the heating period. The samples were examined for any evidence of spalling or separation of the coating after the test.

### EXAMPLE 1

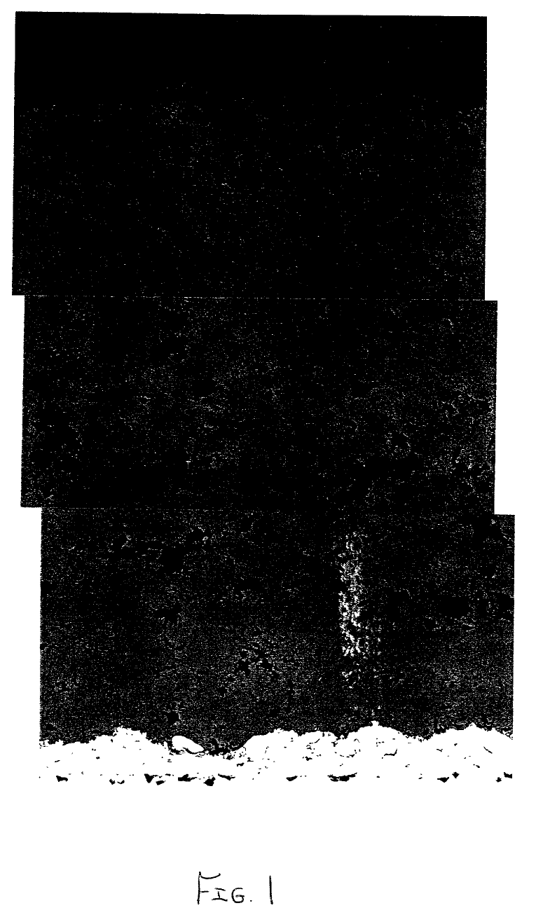

An example of one of the embodiments of the invention comprised a seal coating with a CoNiCrAlY bondcoat, a segmented zirconia first layer, and a low-density zirconia second layer. The 5 mil (0.13 mm) thick bondcoat was deposited using a JP-5000® HVOF torch using a 16 inch (40.6 cm) nozzle. Kerosene fuel at 6 gallons per hour (22 liters per hour) and oxygen gas at 1650 scfh (46.7 sm³/h) formed the combustion mixture. An argon carrier gas injected 130 grams/minute of an alloy with a nominal composition of Co-32Ni-21Cr-8Al-0.5Y in weight percent. A Metco 3MB torch was used to deposit both zirconia layers. The zirconia powder was Praxair Surface Technologies' ZrO-182, a nominal −140 mesh/+325 mesh (−105/+44 micron) powder having about 8 wt. % yttria. For the first layer of zirconia, the torch gas mixture and flow rates were 80 cfh (2.3 sm³/h) argon and 30 cfh (0.8 sm³/h) hydrogen, and the powder carrier was 13 cfh (0.4 sm³/h) argon. The powder feed rate was 50 grams per minute. The torch was operated at 500 amps at about 75 volts with a surface speed of 600 inches/minute (15 m/minute) and advance of 0.25 inch/revolution (6.4 mm/revolution). A crack segmentation pattern was produced with about 40 cracks per inch (15.7 cracks per centimeter) measured along a line parallel to the substrate interface, each countable crack being at least half the ceramic coating thickness. The crack pattern was measured using a light microscope at 100× magnification. The coating density was about 89% theoretical density. The first zirconia layer was about 10 mils (0.25 mm) thick. For the second zirconia layer, the ZrO-182 zirconia powder was blended with 4 weight percent polyester fugitive material. The torch gas mixture and flow rates were 80 cfh (2.3 sm³/h) argon and 15 cfh (0.42 sm³/h) hydrogen, and the powder carrier was 13 cfh (0.36 sm³/h) argon. The mixed powder feed rate was 45 grams per minute. The torch was operated at 500 amps at about 65 volts with a surface speed of 1560 inches/minute (40 m/min.) and an advance of 0.25 inch/revolution (6.4 mm/revolution). The second zirconia layer was about 40 mils (1 mm) thick, had no segmentation cracks, and a density of 65% theoretical density. The microstructure of the coating is shown in FIG. 1.

The rub tolerance of the coating of this example was shown to be better than that of the low density zirconia coatings representative of the current state-of-the-art. In addition, the total coating and the second zirconia layer thickness that could be developed with good thermal shock resistance retained was much greater than with a single layer of state-of-the-art low density zirconia.

The multilayer coating of this example was evaluated in the thermal shock test described above. In this test the front face of the ceramic reached a temperature of 2530° F. (1388° C.), while the opposite, uncoated side of the sample reached a temperature of about 1500° F. (816° C.) at the end of the heating period. The multilayer coating of this example experienced no spallation and only edge cracking of about 30% of the periphery of the coating (average of three specimens) in this very severe thermal shock test. The vertical macrocracks of the inner ceramic layer did not propagate through the outer ceramic layer. Comparable tests of state-of-the-art low density coatings similar to the second layer coatings of this example, but with no inner layer, and of nearly the same total thickness experienced no spallation, but average edge cracking of 67%, over twice that of the coatings of this invention.

### EXAMPLE 2

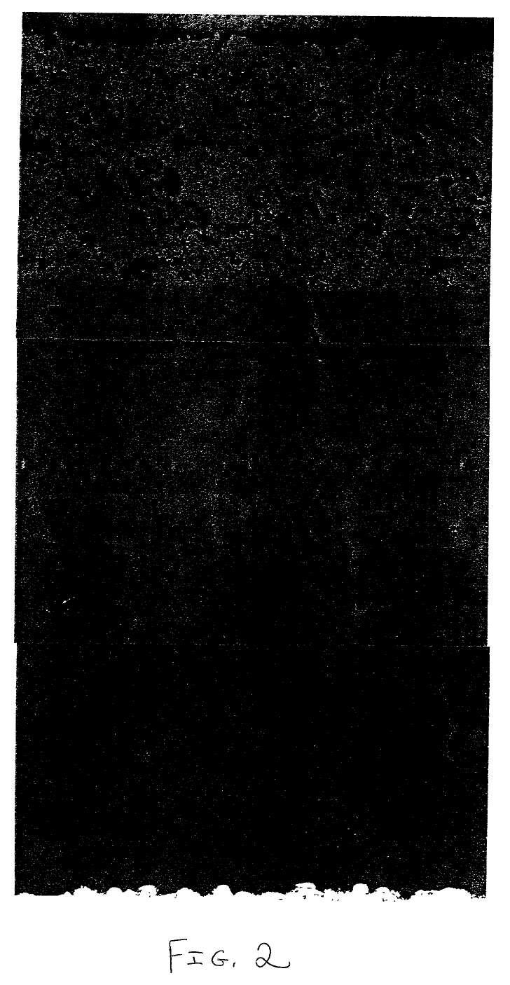

An example of another embodiment of the present invention comprised a seal coating with a CoNiCrAlY bondcoat, a first zirconia layer having vertical microcracks (a segmented microstructure), and a second zirconia layer having a low density without microcracks. The 5 mil (0.13 mm) thick CoNiCrAlY bondcoat had the same composition and was deposited using the same torch and deposition parameters as the bondcoat in Example 1. The first zirconia layer was deposited using ZrO-137, a nominal −63/+11 micron powder with a composition of ZrO₂-7Y₂O₃, by weight percent, and a Praxair Model 1108 torch operated at 170 amps with a mixture of 90 cfh (2.5 sm³/h) argon plus 40 cfh hydrogen (1.1 sm³/h) torch gas and 90 cfh (2.5 sm³/h) argon powder carrier gas with a surface speed of 3750 inches per minute (9.5 m/min.) and advance of 0.25 inch per revolution (6.4 mm/revolution). The second layer of zirconia was deposited using the same powder and deposition parameters as the second zirconia layer in Example 1. The microstructure of this coating is shown in FIG. 2. It consisted of a 5 mil (0.13 mm) thick bondcoat, a 115 mil (2.9 mm) thick first layer of zirconia coating having vertical and horizontal cracks, and a contiguous 40 mil (1 mm) thick second layer of low density zirconia without a microcrack pattern and a density of 65% theoretical density.

The rub tolerance of the coating was the same as that of the low-density zirconia coatings of Example 1 since the second layer of zirconia was the same. However, the total ceramic coating thickness that could be developed with good thermal shock resistance retained was much greater than with single layer of state-of-the-art low density zirconia.

The thermal shock resistance of the coating of this example was characterized in the thermal shock test described above. In this test the temperature of the face of the ceramic reached a temperature of 2600° F. (1427° C.), while the opposite, uncoated face reached a temperature of about 1200° F. (649° C.), at the end of the heating period. The multilayer coating of this example exhibited no spalling, no vertical crack propagation nor separation in this severe thermal shock test.

### EXAMPLE 3

An example of another embodiment of the coatings of this invention are coatings with a metallic bondcoat, a first zirconia coating layer with a macrocrack pattern having a vertically cracked segmentation structure to which is added a controlled horizontal crack pattern (a bricked microstructure), and a second zirconia layer with a low density without a crack pattern. The parameters for depositing the first zirconia layer were determined using a design of experiments (DOE) approach. From previous experiments the basic variables that affect vertical and horizontal cracking were known. Several variables were held constant including the powder and powder feed rate, standoff (distance from the torch to the substrate), and the specific torch and torch operating parameters. A PST model 1108 plasma spray torch was used with a current of 170 amps and an argon-hydrogen gas mixture. The surface speed and advance rate of the torch were varied according to the DOE. The zirconia layer for all of the coatings in the DOE was 34-36 mils (0.86-0.91 mm) thick. The substrates were all 0.125 inch (3.2 mm) thick Mar M-509 alloy substrates one inch (2.5 cm) in diameter with a 5-mil (0.13 mm) bondcoat of Ni-5 weight percent Al, deposited using a PST 1108 torch. The DOE controlled variables and the observed dependent variables are shown below.

The dependent variables of particular interest were the vertical and horizontal cracks. The entire 8-line DOE was repeated three times with new substrates and changes in the controlled deposition parameters. All of the samples were mounted and polished separately. Only one “observer” was used to count all cracks, and three polish planes per specimen were evaluated. The DOE matrix and observed CPI and percent bricking were as follows.

DOE Matrix for 3-D Segmented Zirconia Development

| Surface | | | | | | |
|---|---|---|---|---|---|---|
| Speed | | Advance | | | | |
| inch/ | | | | | | % |
| min. | m/min. | inch/rev. | cm/rev. | CPI* | Cracks/cm | Bricking |
| 950 | 2.4 | 0.0625 | 0.16 | 61, 58, 65 | 24, 23, 26 | 45, 53, 30 |
| 3750 | 9.5 | 0.0625 | 0.16 | 44, 49, 52 | 17, 19, 20 | 5, 8, 9 |
| 950 | 2.4 | 0.25 | 0.64 | 66, 64, 69 | 26, 25, 27 | 32, 21, 17 |
| 3750 | 9.5 | 0.25 | 0.64 | 50, 48, 56 | 20, 19, 22 | 9, 8, 6 |
| 2350 | 6.0 | 0.0625 | 0.16 | 64, 67, 58 | 25, 26, 23 | 22, 17, 17 |
| 2350 | 6.0 | 0.25 | 0.64 | 69, 72, 68 | 27, 28, 27 | 15, 14, 16 |
| 950 | 2.4 | 0.125 | 0.32 | 63, 69, 68 | 25, 27, 27 | 32, 20, 22 |
| 3750 | 9.5 | 0.125 | 0.32 | 50, 59, 55 | 20, 23, 22 | 9, 10, 8 |

*Average values of the three polish planes per sample, showing the three separate coating runs for each of the 8 DOE lines. Values were rounded to whole numbers for this tabulation.

The results for CPI or cracks per centimeter and Percent Bricking were quite comparable between the three runs for any given line of the experiment. The data were analyzed using multiple correlation methods as follows. First the two controlled factors and the three measurement values for CPI or cracks per centimeter were evaluated for the significant factors, allowing for both main factors, squared factors and the interaction factor between surface speed and advance. In this analysis, the independent variables were first standardized (see Basic Statistics, Fourth Edition, authors Kiemele, Schmidt and Berdine, Air Academy Press, 1999), allowing the most significant variables to be identified. For CPI, four terms emerged as significant, the main variables and their squares, with no interaction term. The percent bricking data was treated in the same way, and three terms emerged as significant, the main variables of surface speed and advance plus their interaction. Knowing the significant variables, the data was fit to them without coding using the multiple correlation method. For the DOE above and the range of independent variables selected, the correlation equations were as follows.

CPI=38.15+0.0174*SS+211.2*Adv −4.724*(SS/1000)²−592.2*(Adv)²

Cracks/cm=CPI/2.54% Bk=53.16−0.01238*SS−109.79*Ad +0.0309*SS*Adv

where SS is the surface speed (inches/min.) and Adv is the advance (inches/revolution). If there was a need to design a coating with high bricking, for example, slow surface speed and slow advance would be favored. These results only strictly apply to the coating density obtained using the PST model 1108 torch and the powder and deposition parameters used here. However, the DOE method described here can be applied to other torch and powder systems. A similar DOE matrix was used to develop crack patterns using ZrO-182 powder and the Metco 3MB torch.

The thermal shock resistance of the coatings in the DOE above was characterized using the thermal shock test described above. Only the coating in the first line of the DOE exhibited spalling of the coating. This coating had the highest combination of CPI (cracks per centimeter) and Percent Bricking. None of the coatings of the other lines exhibited any spalling and had no edge cracking or only minor edge cracking when examined at 30× magnification.

A multilayer system could readily be constructed having a metallic bondcoat, one of the coatings above with bricked microstructure inner layers and a second layer of zirconia having the same low density zirconia described in Examples 1 and 2. Such a multilayer coating would have the same rub tolerance as described in Example 1. However, because of the unique bricked microstructure, these coatings may be used for rub tolerance without the addition of the low-density second layer of zirconia in some applications.

### EXAMPLE 4

An example of another embodiment of this invention comprises designing a multilayer coating to have a specific thermal conductivity as shown in the Table below using just two of the multilayer coatings described above. The first layer is a dense, vertically segmented yttria-stabilized zirconia coating. The coating is about 92 percent dense and would have about 50 vertical segmentation cracks per inch (20 cracks per centimeter). The horizontal branch cracks that extend from some of the vertical cracks can be characterized in part by the percent bricking defined earlier. In this case the percent bricking is assumed to be about 10 percent.

The second layer in the example is a low-density abradable layer that would be used as the upper layer in the multilayer coating. This coating has a density of about 65 percent of theoretical, with no vertical segmentation cracks, nor little recognizable horizontal cracking at the normal 100× magnification view of the polished cross section. From the individual layer thermal conductivity values, the table below demonstrates the thermal conductivity and the calculated temperature drop across a total multilayer thickness of 80 mils (2 mm) for different combinations of layer thickness of the inner and outer layers.

| Layer 1 | | | | | | |
|---|---|---|---|---|---|---|
| (Segmented | | Layer 2 | | | | Apparent |
| zirconia) | | (65% density) | | Total Temp. | | Thermal |
| Thickness | | Thickness | | Drop | | Conductivity |
| mils | mm | Mils | mm | ° F. | ° C. | W/cm/° K. |
| 60 | 1.5 | 20 | 0.5 | 381 | 212 | 0.00583 |
| 40 | 1.0 | 40 | 1.0 | 499 | 277 | 0.00511 |
| 20 | 0.5 | 60 | 1.5 | 605 | 336 | 0.00460 |

The assumptions used in this simplified demonstration calculation are one dimensional heat flow with no radiation or convection, and no interface resistance between layers, a heat flux of 60 watts, and a temperature of 2550° F. (1399° C.) at the outer surface of layer 2.

In practice, the composite multilayer would be made and the whole system measured using a method such as the laser flash method to determine the actual thermal conductivity of the composite. The actual temperature drop across such a composite multilayer would depend on the actual temperature of the front face and the effective heat flux delivered to the front face by the actual environment as well as the temperature of the substrate and its heat flux. The calculation illustrates the further thermal conductivity design possibilities offered by the multilayer coating systems.

Generally, the multilayer coatings provide excellent thermal barriers and excellent abradables. They facilitate providing coatings that are much thicker than previously was possible for excellent thermal shock and thermal fatigue resistance coatings. For example, the inner and outer layers may have a total thickness of about 0.2 mm to about 10 mm, advantageously in excess of about 2 mm, and, most advantageously, a total thickness of about 2 to 5 mm. Most advantageously, the outer ceramic layer has sufficient integrity or strength to prevent vertical macrocracks from the inner ceramic layer from propagating through the outer ceramic layer during the coating's initial thermal cycling. The outer ceramic layer, however, may experience limited cracking over extended operation of gas turbine devices, but the unique multilayer structure of the coating appears to limit the spalling often associated with cracking. In addition, it can provide thermal barrier coatings with a predetermined thermal conductivity—these coatings usually comprise multiple layers of ceramic materials with different microstructures that also provide the coating system with much greater thermal shock resistance.

The coating systems may find utility in both the turbine and compressor sections of gas turbine engines and in other applications. For example, the substrate coated is advantageously a component of a gas turbine engine, such as an air seal for a gas turbine engine. Most advantageously the multilayer coating is an abradable coating; and these abradable coatings are particularly useful as air seals that oppose a blade tip or knife edge.

Many possible embodiments may be made of this invention without departing from the scope thereof, it is understood therefore that all matter set forth herein is to be interpreted as illustrative and not in a limiting sense.

What is claimed is:

1. A multilayer ceramic coating for providing thermal barrier protection to a substrate comprising an inner ceramic layer coating the substrate, the inner ceramic layer having a plurality of macrocracks distributed throughout the inner ceramic layer, and an outer ceramic layer coating the inner ceramic layer, the outer ceramic layer being substantially free of vertical macrocracks.

2. The multilayer coating of claim 1 wherein the cracks of the inner ceramic layer are vertical macrocracks.

3. The multilayer coating of claim 1 wherein the cracks of the inner ceramic layer are vertical and horizontal macrocracks.

4. The multilayer coating of claim 1 wherein the inner ceramic layer includes at least a first cracked layer and a second cracked layer.

5. The multilayer coating of claim 1 wherein the inner ceramic layer has a porosity that increases from an inner surface of the inner ceramic layer to an outer surface of the inner ceramic layer.

6. The multilayer coating of claim 1 wherein the outer ceramic layer has a porosity that increases from an inner surface of the outer ceramic layer to an outer surface of the outer ceramic layer.

7. The multilayer coating of claim 1 wherein the cracks are vertical macrocracks that extend at least the lesser of about 0.1 mm in length or one half the thickness of the inner ceramic layer.

8. The multilayer coating of claim 1 wherein the cracks are vertical segmentation macrocracks that extend at least one half the thickness of the inner ceramic layer and there are from about 7.5 to 75 vertical macrocracks per linear centimeter.

9. The multilayer coating of claim 3 wherein the total horizontal macrocracks extend from about 15 to 100% as measured across a plane normal to an interface of the substrate with the multilayer coating.

10. The multilayer coating of claim 9 wherein the total horizontal macrocracks extend from about 20 to 60% as measured across a plane normal to an interface of the substrate with the multilayer coating.

11. A multilayer zirconia-based coating for providing thermal barrier protection to a substrate comprising an inner zirconia-based layer coating the substrate, the inner zirconia-based layer having a plurality of vertical macrocracks distributed throughout the inner zirconia-based layer, and an outer zirconia-based layer coating the inner zirconia-based layer, the outer zirconia-based layer being substantially free of vertical macrocracks.

12. The multilayer zirconia-based coating of claim 11 wherein the inner zirconia-based layer includes horizontal macrocracks.

13. The multilayer zirconia-based coating of claim 11 wherein the inner zirconia-based includes at least a first cracked layer and a second cracked layer.

14. The multilayer coating of claim 11 wherein the inner zirconia-based layer has a porosity that increases from an inner surface of the inner zirconia-based layer to an outer surface of the inner zirconia-based layer.

15. The multilayer coating of claim 11 wherein the outer zirconia-based layer has a porosity that increases from an inner surface of the outer zirconia-based layer to an outer surface of the outer zirconia-based layer.

16. The multilayer zirconia-based coating of claim 11 wherein there are from about 7.5 to 75 of the vertical segmentation macrocracks per linear centimeter.

17. The multilayer zirconia-based coating of claim 12 wherein the horizontal macrocracks are from about 0.1 to 2.5 mm in length and the total horizontal macrocracks extend from about 15 to 100% as measured across a plane normal to an interface of the substrate with the multilayer zirconia-based coating.

18. The multilayer zirconia-based coating of claim 17 wherein the total horizontal macrocracks extend from about 20 to 60% as measured across a plane normal to an interface of the substrate with the multilayer zirconia-based coating.

19. The multilayer zirconia-based coating of claim 11 wherein the outer zirconia-based layer has a density of about 45 to 90% of theoretical.

20. The multilayer zirconia-based coating of claim 11 wherein the outer zirconia-based layer has a density of about 50 to 86% of theoretical.

21. The multilayer zirconia-based coating of claim 11 wherein the outer zirconia-based layer has a density of about 50 to 70% of theoretical.

22. The multilayer zirconia-based coating of claim 11 wherein the inner and outer zirconia-based layers have a total thickness of about 0.2 mm to about 10 mm.

23. The multilayer zirconia-based coating of claim 11 wherein the inner and outer zirconia-based layers have a total thickness of at least about 2 mm.

24. The multilayer zirconia-based coating of claim 11 wherein the multilayer zirconia-based coating contains a stabilizing element for partially or full stabilizing the at least one crystallographic phase selected from the group of tetragonal and cubic.

25. The multilayer zirconia-based coating of claim 11 including a bondcoat between the substrate and the inner zirconia-based layer.

26. The multilayer zirconia-based coating of claim 25 wherein the bondcoat contains at least one inner sublayer and an outer sublayer, and the outer sublayer has a surface roughness of at least about 3.8 μm as measured before the application of the inner zirconia-based layer to the outer sublayer.

27. The multilayer zirconia-based coating of claim 25 wherein the bondcoat is sealed with a heat treatment.

28. A substrate having a multilayer ceramic coating for providing thermal barrier protection to at least a portion of the substrate, the multilayer ceramic coating comprising an inner ceramic layer coating the substrate, the inner ceramic layer having a plurality of cracks distributed throughout the inner ceramic layer, and an outer ceramic layer coating the inner ceramic layer, the outer ceramic layer being substantially free of vertical macrocracks.

29. The substrate of claim 28 wherein the substrate is a component of a gas turbine engine.

30. The substrate of claim 28 wherein the substrate is an air seal for a gas turbine engine.

31. The substrate of claim 30 wherein the multilayer coating is an abradable coating.

32. The substrate of claim 31 wherein the air seal opposes a blade tip or knife edge.

33. A substrate having a multilayer zirconia-based coating for providing thermal barrier protection to at least a portion of the substrate, the multilayer zirconia-based coating for providing thermal barrier protection to a substrate comprising an inner stabilized zirconia layer coating the substrate, the inner stabilized zirconia layer having a plurality of vertical macrocracks distributed throughout the inner stabilized zirconia layer, and an outer stabilized zirconia layer coating the inner stabilized zirconia layer, the outer stabilized zirconia layer being substantially free of vertical macrocracks.

34. The substrate of claim 33 wherein the substrate is a component of a gas turbine engine.

35. The substrate of claim 33 wherein the substrate is an air seal for a gas turbine engine.

36. The substrate of claim 35 wherein the multilayer coating is an abradable coating.

37. The substrate of claim 36 wherein the air seal opposes a blade tip or knife edge.

38. The substrate of claim 33 wherein the inner stabilized zirconia layer contains a first layer having a first conductivity and a first thickness and a second layer having a second thermal conductivity and a second thickness for combining two different thermal conductivities and for forming a desired total thermal conductivity and a desired total thickness.
